(19) United States
(12) Patent Application Publication
(10) Pub. No.: US 2025/0385753 A1
(43) Pub. Date: Dec. 18, 2025

(54) REFERENCE CHANNEL STATE INFORMATION REFERENCE SIGNAL (CSI-RS) FOR MACHINE LEARNING (ML) CHANNEL STATE FEEDBACK (CSF)

(71) Applicant: QUALCOMM Incorporated, San Diego, CA (US)

(72) Inventors: Pavan Kumar VITTHALADEVUNI, San Diego, CA (US); Taesang YOO, San Diego, CA (US); Chenxi HAO, Beijing (CN); Yu ZHANG, San Diego, CA (US); June NAMGOONG, San Diego, CA (US); Tingfang JI, San Diego, CA (US); Jay Kumar SUNDARARAJAN, San Diego, CA (US); Krishna Kiran MUKKAVILLI, San Diego, CA (US); Naga BHUSHAN, San Diego, CA (US); Abdelrahman Mohamed Ahmed Mohamed IBRAHIM, San Diego, CA (US); Runxin WANG, San Diego, CA (US)

(21) Appl. No.: 18/879,600

(22) PCT Filed: May 26, 2023
(86) PCT No.: PCT/CN2023/096544

§ 371 Date: Dec. 27, 2024

(30) Foreign Application Priority Data
Aug. 27, 2022 (WO) PCT/CN2022/115322

(51) Int. Cl. H04L 1/00; H04B 7/06; H04B 17/309; H04B 17/318; H04L 5/00

(52) U.S. Cl. CPC H04L 1/0026; H04B 7/0632; H04B 17/328; H04B 17/346; H04L 5/0051

(57) ABSTRACT

An apparatus for wireless communication at a UE is provided. The apparatus is configured to receive a first channel state information reference signal (CSI-RS) from a network entity through a transmission channel. The apparatus is further configured to receive a second CSI-RS that has a higher resolution than the first CSI-RS, and determine channel information of the transmission channel and a target output based on the second CSI-RS. The apparatus is further configured to transmit the channel information and the target output to the network entity.

### CROSS REFERENCE TO RELATED APPLICATIONS

This application claims the benefit of and priority to International Application No. PCT/CN2022/115322, entitled “REFERENCE CHANNEL STATE INFORMATION REFERENCE SIGNAL (CSI-RS) FOR MACHINE LEARNING (ML) CHANNEL STATE FEEDBACK (CSF)” and filed on Aug. 27, 2022, which is expressly incorporated by reference herein in its entirety.

### TECHNICAL FIELD

The present disclosure relates generally to communication systems, and more particularly, to wireless communication including a reference channel state information reference signal (CSI-RS).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives a first channel state information reference signal (CSI-RS); receives a second CSI-RS, the second CSI-RS having a higher resolution than the first CSI-RS; and transmits channel information of the transmission channel and a target output, the channel information and the target output associated with the second CSI-RS.

In an aspect of the disclosure, a method, a computer-readable medium, and an apparatus are provided for wireless communication at a network node. The apparatus transmits, to a user equipment (UE), through a transmission channel, a first channel state information reference signal (CSI-RS); transmits, to the UE, a second CSI-RS, the second CSI-RS having a higher resolution than the first CSI-RS; and receives, from the UE, channel information of the transmission channel and a target output, the channel information and the target output associated with the second CSI-RS.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating the encoding/decoding process in a wireless communication.

FIG. 4B is a diagram illustrating an example of a lower resolution CSI-RS and a higher resolution CSI-RS.

FIG. 5 is a call flow diagram illustrating methods of wireless communication in accordance with various aspects of the present disclosure.

FIG. 6 illustrates example aspects of a machine learning algorithm for wireless communication.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a diagram illustrating an example of a hardware implementation for an example apparatus and/or UE.

FIG. 10 is a flowchart illustrating methods of wireless communication at a network entity in accordance with various aspects of the present disclosure.

FIG. 11 is a flowchart illustrating methods of wireless communication at a network entity in accordance with various aspects of the present disclosure.

FIG. 12 is a diagram illustrating an example of a hardware implementation for an example network entity.

### DETAILED DESCRIPTION

A network may configure a UE to measure a channel state information reference signal (CSI-RS). The UE may perform measurements on the CSI-RS, e.g., to estimate the channel from the network. The UE may report channel state information (CSI) to the network based on the measurements. Aspects presented herein enable improved CSI reporting using compressed CSI that reduces the overhead for the UE to provide the network with the CSI. The UE may further provide the network with information that the network can use to decode and/or denoise compressed CSI from the UE. The aspects presented herein enable improved communication between the network and UE with reduced overhead for CSI reporting by enabling accurate CSI reporting and reception using compressed CSI.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination, e.g., individually or collectively. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

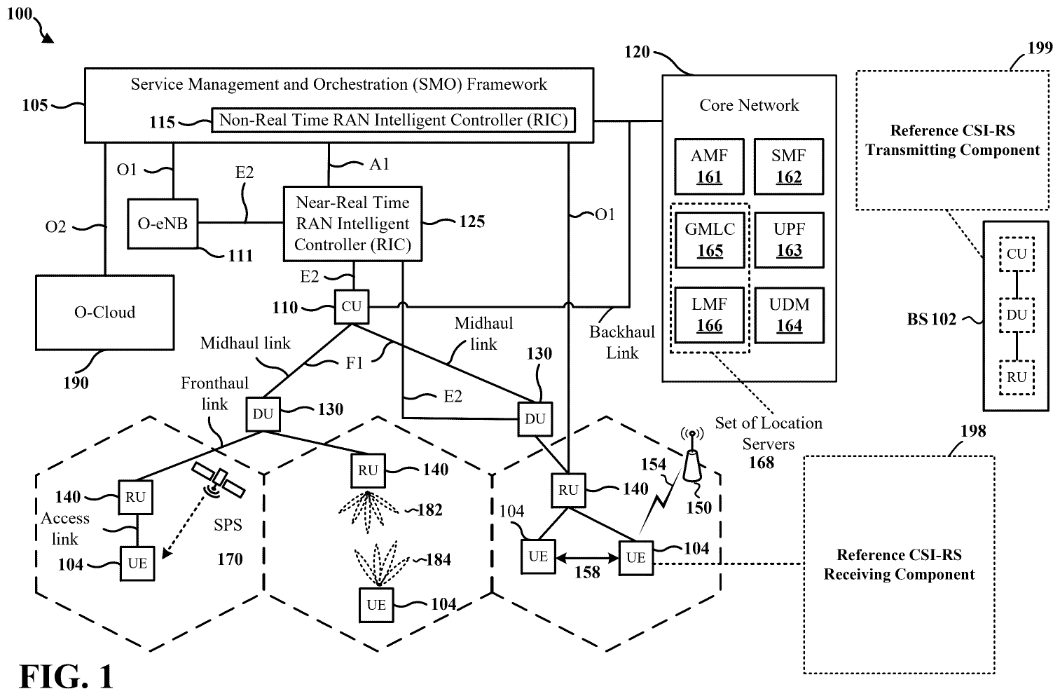

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a CSI-RS receiving component 198 configured to receive a first channel state information reference signal (CSI-RS); receive a second CSI-RS, the second CSI-RS having a higher resolution than the first CSI-RS; and transmit channel information of the transmission channel and a target output, the channel information and the target output associated with the second CSI-RS. In certain aspects, the base station 102 may include a CSI-RS transmitting component 199 configured to transmit, to a user equipment (UE), through a transmission channel, a first CSI-RS; transmit, to the UE, a second CSI-RS, the second CSI-RS having a higher resolution than the first CSI-RS; and receive, from the UE, channel information of the transmission channel and a target output, the channel information and the target output associated with the second CSI-RS.

Although the following description may be focused on 5G NR, the concepts described herein may be applicable to other similar areas, such as LTE, LTE-A, CDMA, GSM, and other wireless technologies.

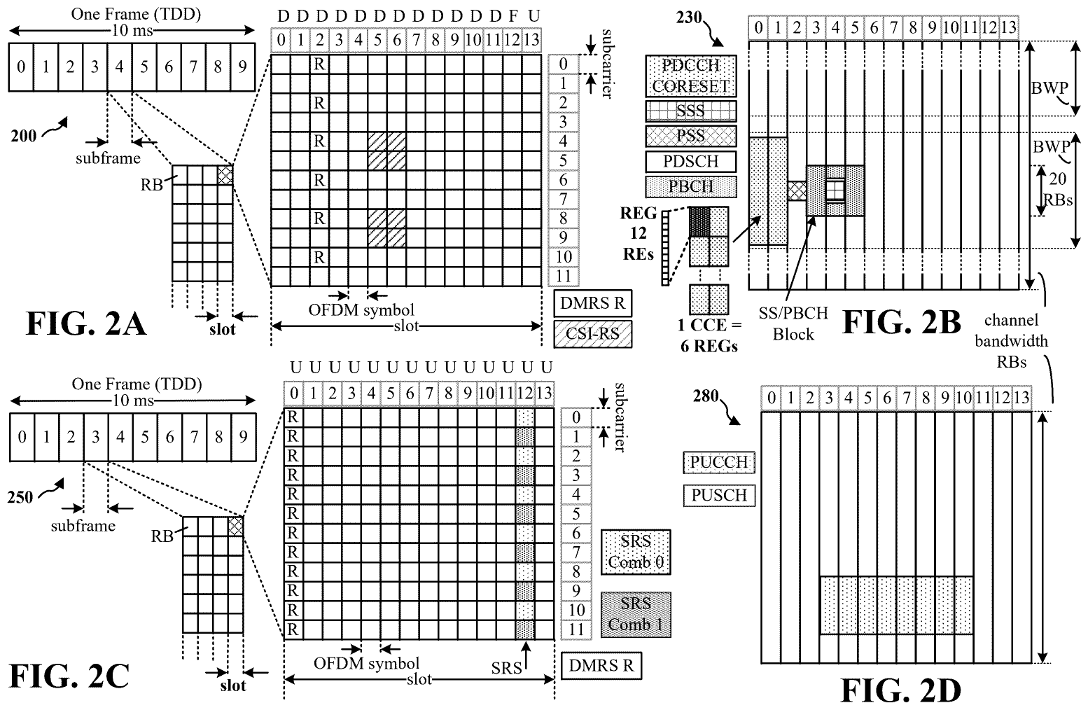

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

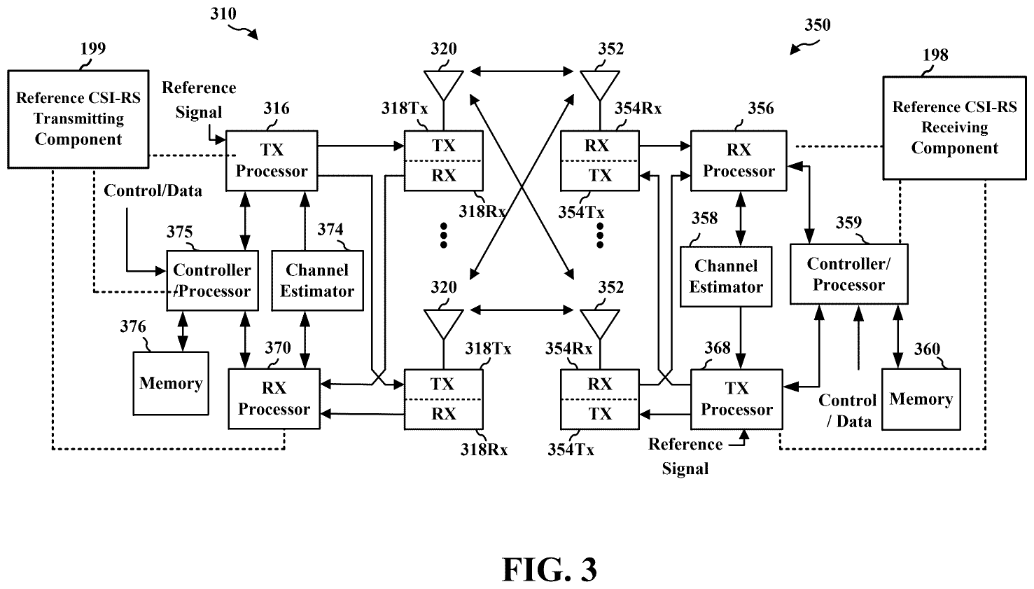

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reference CSI-RS receiving component 198 of FIG. 1.

At least one of the TX processor 316, the RX processor 370, and the controller/processor 375 may be configured to perform aspects in connection with the reference CSI-RS transmitting component 199 of FIG. 1.

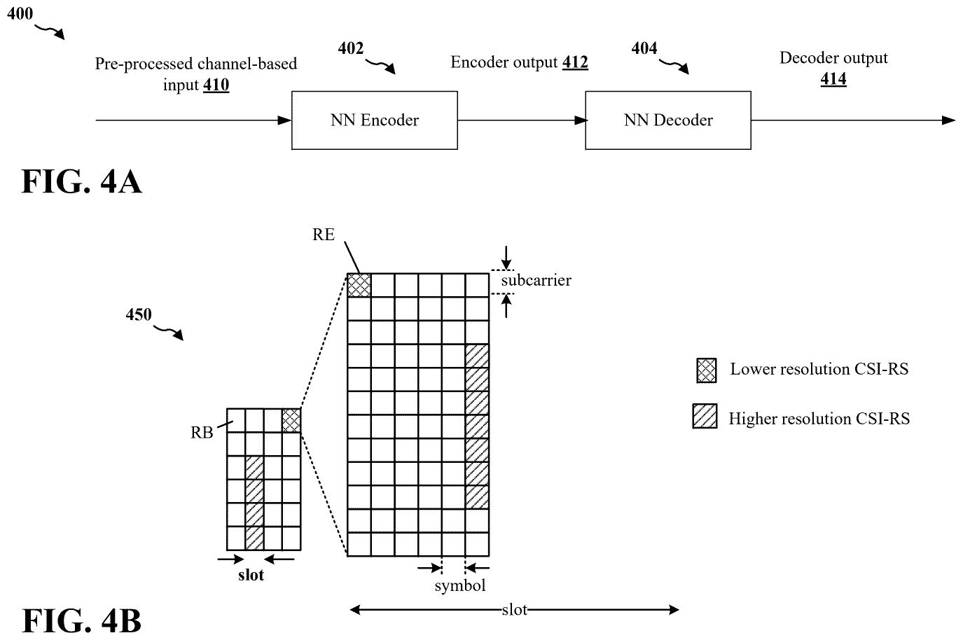

FIG. 4A is a diagram 400 illustrating the encoding/decoding process in a wireless communication. As shown in FIG. 4A, in a wireless communication between a base station and a UE, a pre-processed channel-based input 410 may be provided to a neural network (NN) encoder 402. The NN encoder 402 may encode the pre-processed channel-based input 410 to generate an encoder output 412, which may be fed to an NN decoder 404. The NN decoder 404 may decode the received encoder output 412 to generate a decoder output 414. The NN encoder 402 may be deployed at the UE, and the NN decoder 404 may be deployed at the base station. The pre-processed channel-based input 410 the NN encoder 402 encodes may be a channel estimation signal, and the encoded output 412 may be encoded channel estimation signal. Upon receiving the encoded output 412 (e.g., the encoded channel estimation signal), the NN decoder 404 may decode the received encoded output 412 to generate the decoder output 414. To accurately generate the decoder output, the NN decoder 404 may need to be properly trained with ground-truth signals. Additionally, while being transmitted from the NN encoder 402 to the NN decoder 404, the encoder output 412 may be contaminated by, for example, noise signal during the transmission. Hence, a denoising process may need to be performed on encoded signal received from the UE to improve accuracy.

This present disclosure presents a method of wireless communication to address these issues. According to one aspect of the present disclosure, a UE may receive, through a transmission channel, a first CSI-RS and a second CSI-RS that has a higher resolution than the first CSI-RS. The UE may further transmit channel information of the transmission channel and a target output to a network entity. The channel information and the target output may be associated with the second CSI-RS. By providing a target output associated with the second CSI-RS to the network entity, this method enables the network entity to accurately train a neural network for decoding the encoded signal received from the UE and perform the denoising process on the encoded signal. Thus, it improves the efficiency and accuracy of wireless communication.

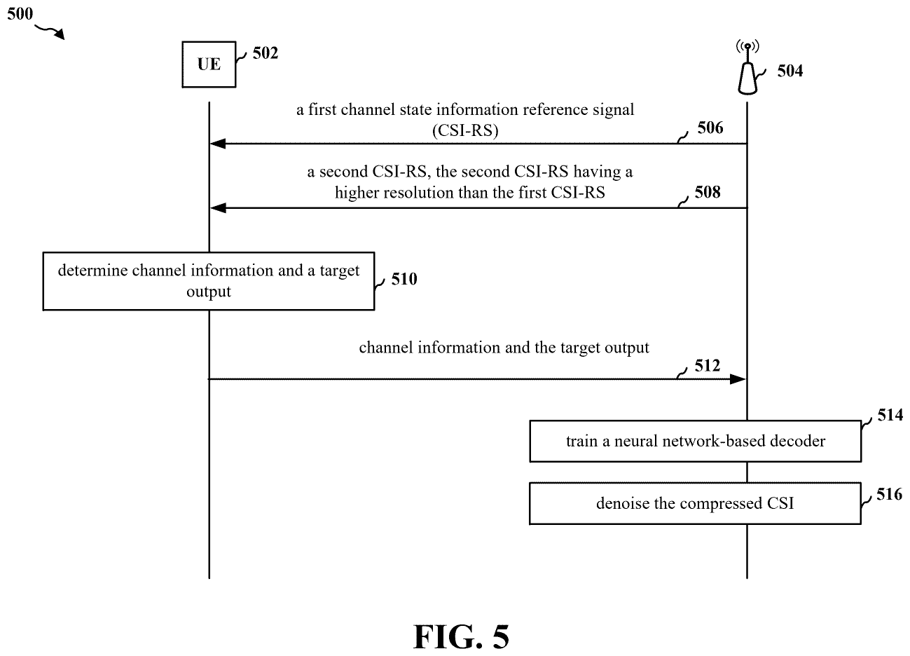

FIG. 5 is a call flow diagram 500 illustrating methods of wireless communication in accordance with various aspects of the present disclosure. As shown in FIG. 5, a network entity (base station 504) may transmit, at 506, a first CSI-RS to a UE 502. The network entity (base station 504) may further transmit, at 508, a second CSI-RS to the UE 502. The second CSI-RS may have a higher resolution than the first CSI-RS. FIG. 4B is a diagram 450 illustrating examples of a lower resolution CSI-RS that may span fewer frequency resources than a higher resolution CSI-RS. For example, the lower resolution CSI-RS may be transmitted on a single RB, and the higher resolution CSI-RS may be transmitted on multiple RBs. Similarly, as shown in FIG. 4B, the lower resolution CSI-RS may be transmitted on a single RE, and the higher resolution CSI-RS may be transmitted on multiple REs.

At 510, the UE 502 may determine channel information and a target output based, at least, on the second CSI-RS. In some examples, the target output may include the expected or desired measurement results on the UE 502 based on the second CSI-RS. The measurement results may include, for example, the RSRP and the signal to interference plus noise ratio (SINR) based on the second CSI-RS. At 512, the UE 502 may transmit the channel information and the target output to the network entity (base station 504). The network entity may, at 514, train a neural network-based decoder based on the channel information and the target output. The network entity may also, at 516, denoise a compressed CSI received from the UE 502 based on the channel information and the target output.

Referring to FIG. 5, the second CSI-RS the network entity (base station 504) transmits, at 508, to the UE 502 may be referred to as a reference CSI-RS, a higher resolution CSI-RS, etc. The reference CSI-RS may be a special CSI-RS that allows the UE to estimate the channel in more detail than the lower resolution CSI-RS. The UE may use the channel estimate to compute a target decoder output (which may also be referred to as a “target output”) of the auto-encoder for compressing/decompressing the channel estimate. The reference CSI-RS may be configured to work with machine learning (ML) channel state feedback (CSF), in some aspects. In the ML CSF, the UE may determine a channel estimation, and use a neural network (NN)-based encoder to compress the channel estimation. Then, the UE may send the compressed channel estimation to the base station. Upon receiving the compressed channel estimation, the base station may use an NN-based decoder to decompress the received compressed channel estimation to obtain a decoder output. To ensure accurate decoder output, the UE may provide a target decoder output to the base station. For example, the UE may send a tuple that includes the compressed channel estimation and the target decoder output to the base station. In one example, the UE may obtain a channel estimation H and generate one or more singular vectors V based on the channel estimation H. The one or more singular vectors V may be the target decoder output, and the UE may send a tuple that includes the channel estimation H and the one or more singular vectors V to the base station. This information may facilitate the base station to train its own neural network for decoding the compressed CSI received from the UE. Additionally, the UE may send a tuple that includes NN decoder output from low-resolution regular CSI-RS and NN decoder output from reference CSI-RS, which has a higher resolution than the regular CSI-RS, to the base stations. For example, the UE may send to the base station a tuple that includes singular vectors V associated with low-resolution regular CSI-RS and singular vector Vref associated with high-resolution reference CSI-RS. This information may facilitate the base station for denoising the compressed channel estimation (e.g., compressed CSI) received from the UE.

In this disclosure, the low-resolution regular CSI-RS may refer to a CSI-RS that has sparse tones, while the high-resolution reference CSI-RS may refer to a CSI-RS that has more dense tones. For example, a low-resolution regular CSI-RS may use one Resource Element (RE) per Resource Block (RB), while a high-resolution CSI-RS may use multiple REs per RB.

The information sent in response to the reference CSI-RS may further contain additional information related to the channel estimation. For example, the UE may apply singular value decomposition on the channel estimation to obtain right singular vectors V, singular values S and left singular vectors U. The UE may send to the base station one or more of: the right singular vectors V, the singular values S, and the left singular vectors U. Additionally, the UE may also send the CQI and/or the RI to the base station.

The right singular vectors V are particularly useful for the base station, as they may be used to indicate the DL beam forming (i.e., the right singular vectors V may indicate a direction in the channel where the highest SNR may be achieved). Individual elements of the target output may be quantized for transmission. For example, when the target output includes the right singular vectors V, individual elements of the right singular vectors V may be quantized at a certain quantization level (i.e., at a certain number of bits), and the quantization level may be signaled by the base station. As used herein, the “quantization level” of a signal may refer to the number of discrete levels or steps into which the signal is divided during the quantization process. For example, a quantization level of 3-bit means a signal will be divided into 8 (2³=8) discrete levels during the quantization process. Alternatively, the right singular vectors V may be transmitted in eType 2 style. In the eType 2 style, the right singular vectors V may be quantized in the form of W1*W2, where W1 and W2 are individual matrices that have a resolution higher than what eType 2 already supports. For example, the number of beams used for generating the reference CSI-RS may be larger than six, using W2 with finer quantization than for normal eType2. In one configuration, the target output may be transmitted with the advanced eType2 style, in which W1*W2*Wf′ is used. Each of W1, W2 and Wf′ may have a higher resolution than what the latest eType 2 supports to achieve finer quantization resolution.

In some aspects, the information related to the reference CSI-RS may be transmitted from the UE to the base station with a high level of accuracy (e.g., with the finest potential quantization level) to ensure the accuracy of the base station's own neural network for decoding or denoising the channel information.

The base station may transmit the reference CSI-RS periodically, in some aspects. In other aspects, the base station may transmit the reference CSI-RS aperiodically. In some aspects, the base station may transmit the reference CSI-RS semi-persistently for a particular duration of time. In some aspects, when the UE determines that the channel condition has substantially changed (for example, due to the movement of the UE or the change in the base station), the UE may send a request for the reference CSI-RS. Such a request may initiate a new periodic/aperiodic/semi-persistent reference CSI-RS transmission(s). For example, the request may trigger an aperiodic reference CSI-RS transmission. The request may trigger the base station to change a periodicity of a periodic reference CSI-RS transmission, or to initiate a new or adjusted periodic reference CSI-RS transmission, or to initiate or adjust a semi-persistent reference CSI-RS transmission. The new reference CSI-RS transmission may have a new transmission behavior that is adapted to the changed channel conditions. For example, the new transmission of the reference CSI-RS may have an increase or decrease of the transmission periodicity, depending on the changed channel conditions.

The reference CSI-RS may be transmitted in various ways. In one configuration, the reference CSI-RS may be transmitted with a broadcast option. In some aspects, the reference CSI-RS may be transmitted jointly, or in common, for multiple UEs in a cell, e.g., or even all the UEs in a cell. As an example, broadcast reference CSI-RS may be coordinated so that the reference CSI-RS may be sent less frequently to save transmission overhead on the DL resources. For example, the UEs in a cell may receive the reference CSI-RS at the same time. For example, the CSI-RS for the UEs may be based on aspects of multimedia broadcast/multicast service (MBMS).

In some aspects, the reference CSI-RS may be transmitted with a unicast option. In the unicast option, based on the sounding reference signal (SRS) received from the UE, the reference CSI-RS may be beamformed along a few significant beams for the UE. In some aspects, to improve the accuracy of the channel estimation at the UE, the reference CSI-RS may also be power boosted to a greater power level than the lower resolution CSI-RS. For example, the reference CSI-RS may have a higher transmission power than a Type 1/eType 2 CSI-RS.

As the information to be transmitted from the UE to the base station may include more detail than for a lower resolution CSI-RS, the amount of UL traffic for the UE to report the channel and decoder output tuples may be large. As a result, the UE's report on UL may be configured as non-delay sensitive transmissions, e.g., with relaxed delay constraints. In some aspects, the UE may transmit the information based on the reference CSI-RS over Wi-Fi and/or during off-peak hours. As an example, the base station may configure the UE to report the tuples over Wi-Fi during off-peak hours to avoid overlapping with other UE traffic on cellular UL. The use of Wi-Fi may help to reduce the overhead on cellular resources.

In some aspects, the base station may set the quantization level of each of the quantities that the UE needs to transmit in response to the reference CSI-RS. The UE may report the channel estimation SNR to the base station, and the base station may adjust the quantization level, or adjust the power-boosting of the reference CSI-RS based on the channel estimation SNRs.

In some aspects, multiple base stations within a certain region may be coordinated to minimize the interference noise when transmitting the reference CSI-RS. For example, when one base station is transmitting the reference CSI-RS on particular tones, adjacent base stations may turn off the transmission on the CSI-RS transmission on those tones to minimize the interference noise.

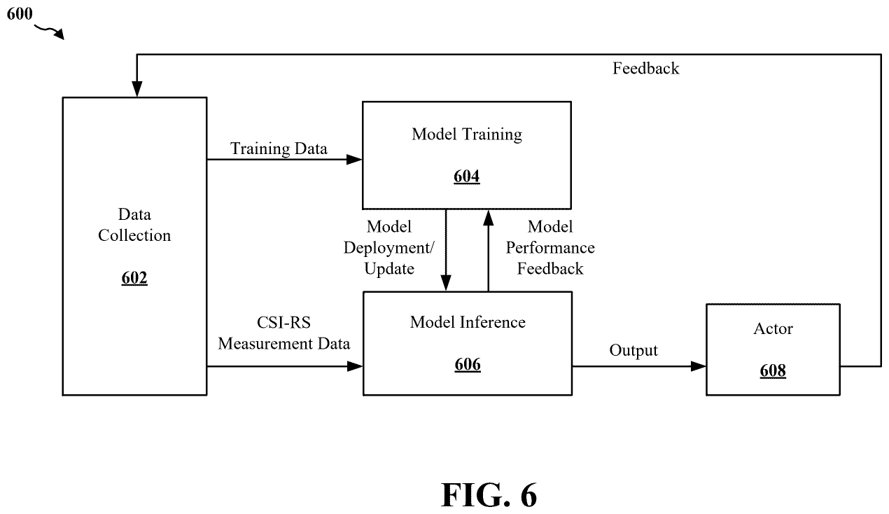

FIG. 6 is an example of the AI/ML algorithm 600 of a method of wireless communication. The AI/ML algorithm 600 may include various functions including a data collection 602, a model training function 604, a model inference function 606, and an actor 608.

The data collection 602 may be a function that provides input data to the model training function 604 and the model inference function 606. For example, the data may include the information provided by one or more UEs (e.g., UE 502) based on a reference CSI-RS, and which may be further based on a non-reference CSI-RS. The data collection 602 function may include any form of data preparation, and it may not be specific to the implementation of the AI/ML algorithm (e.g., data pre-processing and cleaning, formatting, and transformation). The examples of input data may include, but not limited to, measurements, such as RSRP measurements or other TCI candidate information, from network entities including UEs or network nodes, feedback from the actor 608, output from another AI/ML model. The data collection 602 may include training data, which refers to the data to be sent as the input for the AI/ML model training function 604, and inference data, which refers to be sent as the input for the AI/ML model inference function 606.

The model training function 604 may be a function that performs the ML model training, validation, and testing, which may generate model performance metrics as part of the model testing procedure. The model training function 604 may also be responsible for data preparation (e.g., data pre-processing and cleaning, formatting, and transformation) based on the training data delivered or received from the data collection 602 function. The model training function 604 may deploy or update a trained, validated, and tested AI/ML model to the model inference function 606, and receive a model performance feedback from the model inference function 606. FIG. 5 illustrates that a neural network may be trained based on the channel information and target decoder output received from one or more UEs.

The model inference function 606 may be a function that provides the AI/ML model inference output (e.g., predictions or decisions). The model inference function 606 may also perform data preparation (e.g., data pre-processing and cleaning, formatting, and transformation) based on the inference data delivered from the data collection 602 function. The output of the model inference function 606 may include the inference output of the AI/ML model produced by the model inference function 606. The details of the inference output may be use-case specific. As an example, the output may include denoising of a compressed CSI.

The model performance feedback may refer to information derived from the model inference function 606 that may be suitable for the improvement of the AI/ML model trained in the model training function 604. The feedback from the actor 608 or other network entities (via the data collection 602 function) may be implemented for the model inference function 606 to create the model performance feedback.

The actor 608 may be a function that receives the output from the model inference function 606 and triggers or performs corresponding actions. The actor may trigger actions directed to network entities including the other network entities or itself. The actor 608 may also provide feedback information that the model training function 604 or the model interference function 606 to derive training or inference data or performance feedback. The feedback may be transmitted back to the data collection 602.

The network may use machine-learning algorithms, deep-learning algorithms, neural networks, reinforcement learning, regression, boosting, or advanced signal processing methods for aspects of wireless communication including the identification of neighbor TCI candidates for autonomous TCI candidate set updates based on DCI selection of a TCI state.

In some aspects described herein, the network may train one or more neural networks to learn dependence of measured qualities on individual parameters. Among others, examples of machine learning models or neural networks that may be comprised in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., including any of feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at the last layer of the neural network and may traverse layers multiple times.

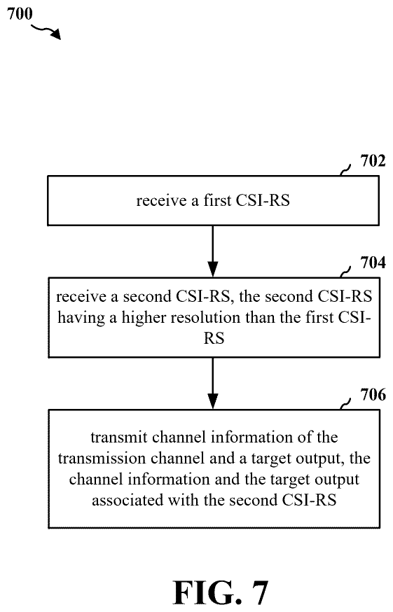

FIG. 7 is a flowchart 700 of a method of wireless communication. The method may be performed by a UE (e.g., the UE 104, 350; the apparatus 904).

At 702, the UE receives a first CSI-RS. The reception may be performed, e.g., by the CSI-RS receiving component 198, transceiver 922 and/or antenna 980.

At 704, the UE receives a second CSI-RS, the second CSI-RS having a higher resolution than the first CSI-RS. The reception may be performed, e.g., by the CSI-RS receiving component 198, transceiver 922 and/or antenna 980. The second CSI-RS may be periodic, aperiodic, or semi-persistent for a preset duration of time. The second CSI-RS may span a larger frequency than the first CSI-RS. In some aspects, the UE may transmit a request for the second CSI-RS, and the second CSI-RS may be received in response to the request for the second CSI-RS. In some aspects, the second CSI-RS may be common to multiple UEs, e.g., coordinated and broadcast to more than one UE. In other aspects, the second CSI-RS may be transmitted to a single UE. In some aspects, the UE may transmit a sounding reference signal (SRS) over one or more beams, and the second CSI-RS may be received along the one or more beams based on the SRS. In some aspects, the second CSI-RS may have a higher transmission power than the first CSI-RS. In some aspects, the UE may transmit a channel estimation signal-to-noise ratio (SNR) and may receive, based on the channel estimation SNR, an adjusted quantization level or the second CSI-RS having an adjusted transmission power.

At 706, the UE transmits channel information of the transmission channel and a target output, the channel information and the target output associated with the second CSI-RS. The transmission may be performed, e.g., by the CSI-RS receiving component 198, transceiver 922 and/or antenna 980. The channel information may include a channel estimation of the transmission channel based on the second CSI-RS. For example, the UE may provide a (channel, target output) tuple to the network. As an example, the target output may include a singular vector or may be a function or combination of singular vectors. In some aspects, the target output information may include a set of singular vectors obtained by taking a singular value decomposition on the channel estimation. In some aspects, the target output may further include one or more of: one or more singular values; one or more right singular vectors or a linear combination of the one or more right singular vectors; one or more left singular vectors or a linear combination of the one or more left singular vectors; a channel quality indicator (CQI) of the transmission channel; or a rank indicator (RI) of the transmission channel. The channel information may include a first set of singular vectors associated with the first CSI-RS, and the target output may include a second set of singular vectors associated with the second CSI-RS. For example, the UE may provide the network with (NN decoder output for a lower resolution CSI-RS (e.g., the first CSI-RS), NN decoder output from a reference CSI-RS (e.g., the second CSI-RS having a higher resolution)).

In some aspects, the UE may further receive an indication of a quantization level, and elements of the target output may be quantized at the quantization level, e.g., a quantization of singular vectors, singular values, etc.

In some aspects, the UE may transmit the channel information of the transmission channel and the target output under a relaxed delay in comparison to the first CSI-RS. As an example, the UE may transmit the channel information of the transmission channel and the target output Wi-Fi. The UE may transmit the channel information and the target output during an off-peak time period, e.g., waiting until off-peak hours to transmit the information to the network. The UE may determine the information and store the information until the off-peak time for transmission.

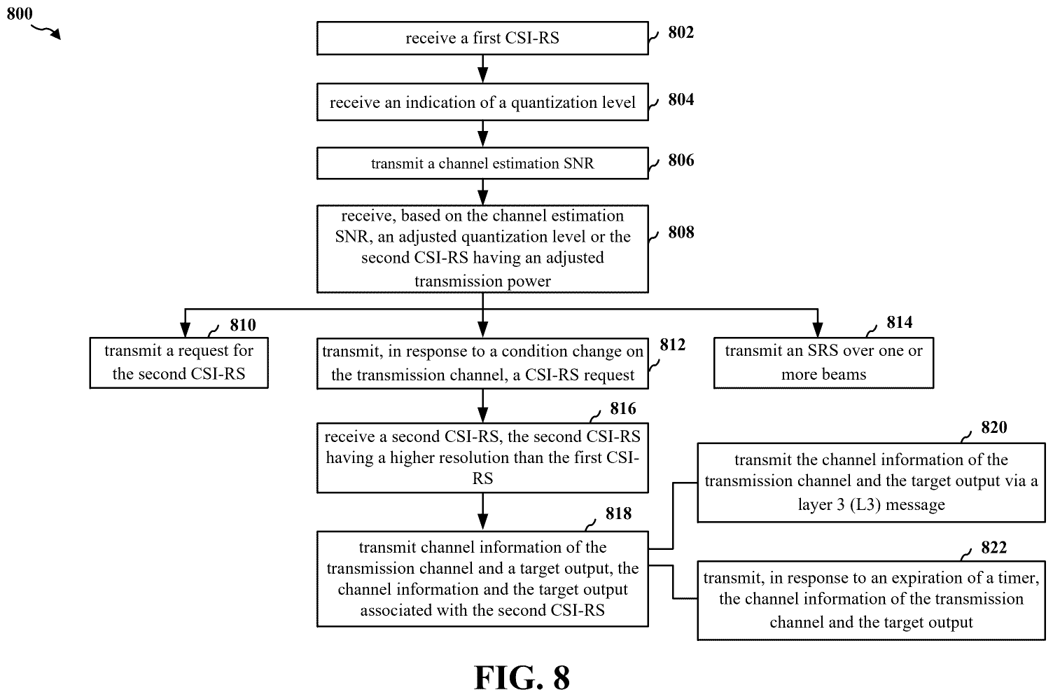

FIG. 8 is a flowchart 800 illustrating methods of wireless communication at a UE in accordance with various aspects of the present disclosure. The method may be performed by a UE (e.g., the UE 104, 350; the apparatus 904).

At 802, the UE receives a first CSI-RS. The reception may be performed, e.g., by the CSI-RS receiving component 198, transceiver 922 and/or antenna 980.

At 816, the UE receives a second CSI-RS, the second CSI-RS having a higher resolution than the first CSI-RS. The reception may be performed, e.g., by the CSI-RS receiving component 198, transceiver 922 and/or antenna 980. The second CSI-RS may be periodic, aperiodic, or semi-persistent for a preset duration of time. The second CSI-RS may span a larger frequency than the first CSI-RS.

In some aspects, the UE may transmit, at 810, a request for the second CSI-RS, and the second CSI-RS may be received in response to the request for the second CSI-RS. The transmission may be performed, e.g., by the CSI-RS receiving component 198, transceiver 922 and/or antenna 980. In some aspects, the second CSI-RS may be common to multiple UEs, e.g., coordinated and broadcast to more than one UE. In other aspects, the second CSI-RS may be transmitted to a single UE. In some aspects, the UE may transmit, at 814, an SRS over one or more beams, and the second CSI-RS may be received along the one or more beams based on the SRS. The transmission may be performed, e.g., by the CSI-RS receiving component 198, transceiver 922 and/or antenna 980. In some aspects, the second CSI-RS may have a higher transmission power than the first CSI-RS. In some aspects, the UE may transmit, at 806, a channel estimation SNR and may receive, at 808, based on the channel estimation SNR, an adjusted quantization level or the second CSI-RS having an adjusted transmission power. The transmission and the reception may be performed, e.g., by the CSI-RS receiving component 198, transceiver 922 and/or antenna 980.

At 818, the UE transmits channel information of the transmission channel and a target output, the channel information and the target output associated with the second CSI-RS. The transmission may be performed, e.g., by the CSI-RS receiving component 198, transceiver 922 and/or antenna 980. The channel information may include a channel estimation of the transmission channel based on the second CSI-RS, and the target output includes a target decoder output associated with the channel estimation. For example, the UE may provide a (channel, target output) tuple to the network. As an example, the target output may include a singular vector or may be a function or combination of singular vectors. In some aspects, the target output information may include a set of singular vectors obtained by taking a singular value decomposition on the channel estimation. In some aspects, the target output may further include one or more of: one or more singular values; one or more right singular vectors or a linear combination of the one or more right singular vectors; one or more left singular vectors or a linear combination of the one or more left singular vectors; a channel quality indicator (CQI) of the transmission channel; or a rank indicator (RI) of the transmission channel. The channel information may include a first set of singular vectors associated with the first CSI-RS, and the target output may include a second set of singular vectors associated with the second CSI-RS. For example, the UE may provide the network with (NN decoder output for a lower resolution CSI-RS (e.g., the first CSI-RS), NN decoder output from a reference CSI-RS (e.g., the second CSI-RS having a higher resolution)).

In some aspects, the UE may further receive, at 804, an indication of a quantization level, and elements of the target output may be quantized at the quantization level, e.g., a quantization of singular vectors, singular values, etc. The reception may be performed, e.g., by the CSI-RS receiving component 198, transceiver 922 and/or antenna 980.

In some aspects, the UE may transmit the channel information of the transmission channel and the target output under a relaxed delay in comparison to the first CSI-RS. As an example, the UE may transmit the channel information of the transmission channel and the target output Wi-Fi. The UE may transmit the channel information and the target output during an off-peak time period, e.g., waiting until off-peak hours to transmit the information to the network. The UE may determine the information and store the information until the off-peak time for transmission.

In some aspects, to transmit the channel information of the transmission channel and the target output at 818, the UE may transmit, at 820, the channel information of the transmission channel and the target output via a layer 3 (L3) message.

In some aspects, to transmit the channel information of the transmission channel and the target output at 818, the UE may transmit, at 822, in response to an expiration of a timer, the channel information of the transmission channel and the target output.

In some aspect, the UE may transmit, at 812, transmit, in response to a condition change on the transmission channel, a CSI-RS request. The transmission may be performed, e.g., by the CSI-RS receiving component 198, transceiver 922 and/or antenna 980. The condition change on the transmission channel may include a change of cross-link interference (CLI), and the change of the CLI may be determined based on a Reference Signal Received Power (RSRP) or a Received Signal Strength Indicator (RSSI) measured by the UE.

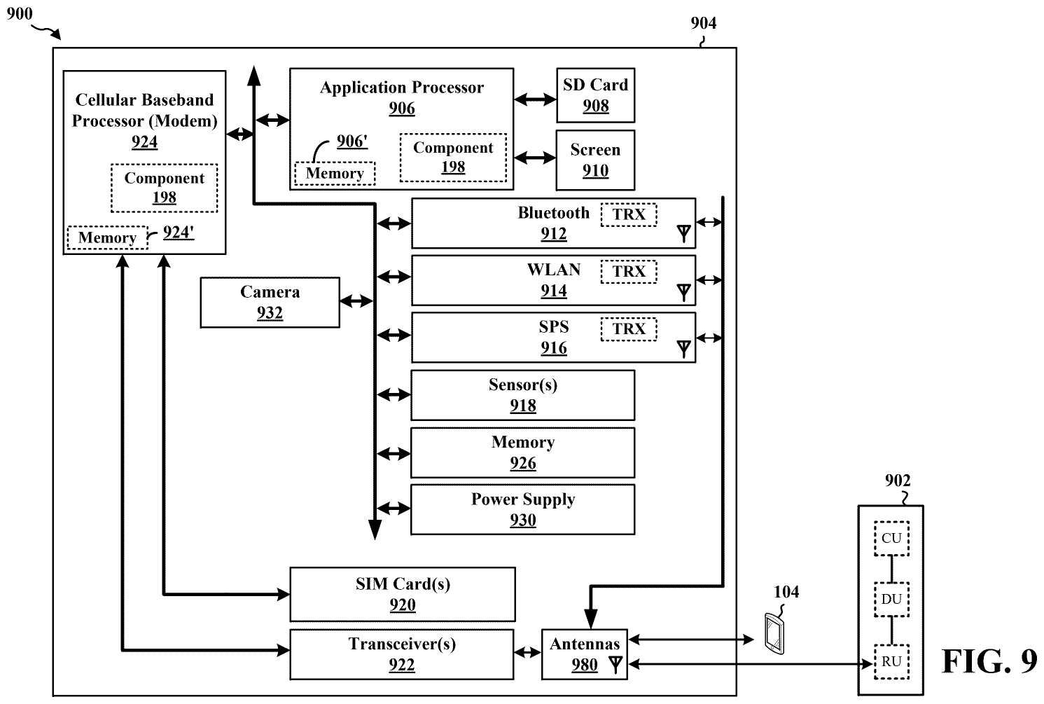

FIG. 9 is a diagram 900 illustrating an example of a hardware implementation for an apparatus 904. The apparatus 904 may be a UE, a component of a UE, or may implement UE functionality. In some aspects, the apparatus 904 may include a cellular baseband processor 924 (also referred to as a modem) coupled to one or more transceivers 922 (e.g., cellular RF transceiver). The cellular baseband processor 924 may include at least one on-chip memory 924′. In some aspects, the apparatus 904 may further include one or more subscriber identity modules (SIM) cards 920 and an application processor 906 coupled to a secure digital (SD) card 908 and a screen 910. The application processor 906 may include on-chip memory 906′. In some aspects, the apparatus 904 may further include a Bluetooth module 912, a WLAN module 914, an SPS module 916 (e.g., GNSS module), one or more sensor modules 918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 926, a power supply 930, and/or a camera 932. The Bluetooth module 912, the WLAN module 914, and the SPS module 916 may include an on-chip transceiver (TRX) (or in some cases, just a receiver (RX)). The Bluetooth module 912, the WLAN module 914, and the SPS module 916 may include their own dedicated antennas and/or utilize the antennas 980 for communication. The cellular baseband processor 924 communicates through the transceiver(s) 922 via one or more antennas 980 with the UE 104 and/or with an RU associated with a network entity 902. The cellular baseband processor 924 and the application processor 906 may each include a computer-readable medium/memory 924′, 906′, respectively. The additional memory modules 926 may also be considered a computer-readable medium/memory. Each computer-readable medium/memory 924′, 906′, 926 may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the at least one memory 360 and/or at least one of the TX processor 368, the RX processor 356, and/or the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see 350 of FIG. 3) and include the additional modules of the apparatus 904.

As discussed supra, the component 198 is configured to receive a first CSI-RS; receive a second CSI-RS, the second CSI-RS having a higher resolution than the first CSI-RS; and transmit channel information of the transmission channel and a target output, the channel information and the target output associated with the second CSI-RS. The component 198 may be further configured to perform any of the aspects described in connection with the flowchart in FIG. 7, the flowchart in FIG. 8, and/or performed by the UE in FIG. 5. The component 198 may be within the cellular baseband processor 924, the application processor 906, or both the cellular baseband processor 924 and the application processor 906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 904 may include a variety of components configured for various functions. In one configuration, the apparatus 904, and in particular the cellular baseband processor 924 and/or the application processor 906, includes means for receiving a first CSI-RS; means for receiving a second CSI-RS, the second CSI-RS having a higher resolution than the first CSI-RS; and means for receiving channel information of the transmission channel and a target output, the channel information and the target output associated with the second CSI-RS. The component 198 may be further configured to perform any of the aspects described in connection with the flowchart in FIG. 7, the flowchart in FIG. 8, and/or performed by the UE in FIG. 5. The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

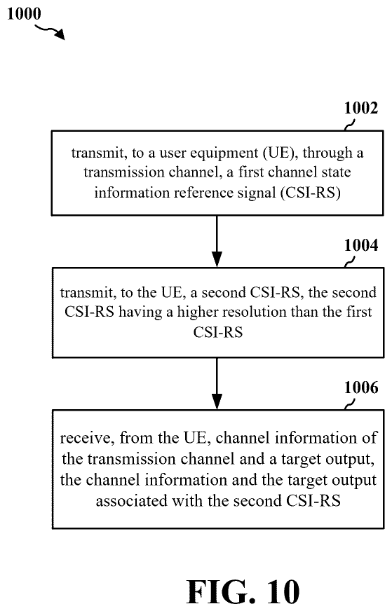

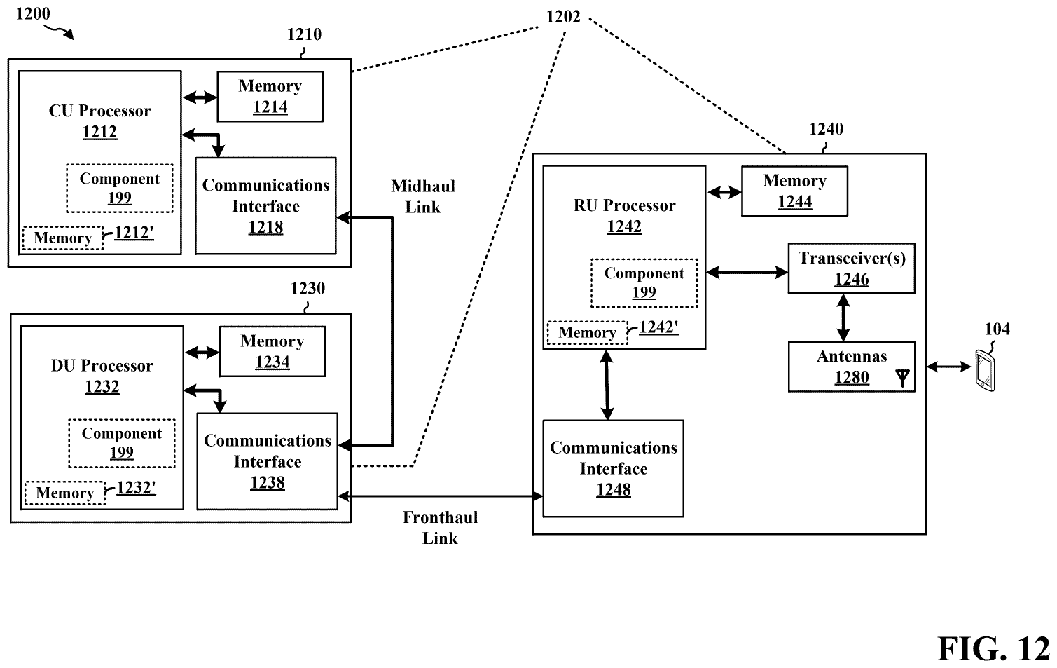

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310; CU 110; DU 130; RU 140; base station 504; or the network entity 1202 in the hardware implementation of FIG. 12). This method enables the network entity to accurately train a neural network for decoding the encoded signal received from the UE and perform the denoising process on the encoded signal. Thus, it improves the efficiency and accuracy of wireless communication.

As shown in FIG. 10, at 1002, the network entity may transmit to a UE, through a transmission channel, a first CSI-RS. The UE may be the UE 104, 350, 502, or the UE 104 in the hardware implementation of FIG. 12. FIG. 5 illustrates various aspects of the wireless communication method in connection with flowchart 1000. For example, referring to FIG. 5, the network entity (base station 504) may transmit, at 506, to a UE 502, through a transmission channel, a first CSI-RS.

At 1004, the network entity may transmit, to the UE, a second CSI-RS. The second CSI-RS may have a higher resolution than the first CSI-RS. For example, referring to FIG. 5, the network entity (base station 504) may transmit, at 508, a second CSI-RS to the UE 502. The second CSI-RS may have a higher resolution than the first CSI-RS.

At 1006, the network entity may receive, from the UE, channel information of the transmission channel and a target output. The channel information and the target output associated with the second CSI-RS. For example, referring to FIG. 5, the network entity (base station 504) may receive, at 512, channel information of the transmission channel and a target output from the UE 502. The channel information and the target output may be associated with the second CSI-RS.

In some aspects, the channel information may include a channel estimation of the transmission channel based on the second CSI-RS, and the target output may include a target decoder output associated with the channel estimation. For example, referring to FIG. 5, the UE 502 may, at 510, determine channel information and a target output based on the second CSI-RS it received at 508. The channel information may include a channel estimation of the transmission channel, and the target output may include a decoder output associated with the channel estimation. Then, at 512, the network entity (base station 504) may receive the channel estimation and the decoder output associated with the channel estimation.

In some aspects, the network entity may train a neural network-based decoder for decoding the channel information of the transmission channel based on the channel estimation and the target decoder output. For example, referring to FIG. 5, the network entity (base station 504) may train, at 514, a neural network-based decoder for decoding the channel information of the transmission channel based on the channel estimation and the target decoder output.

In some aspects, the target output may further include one or more of: one or more singular values; one or more right singular vectors or a linear combination of the one or more right singular vectors; one or more left singular vectors or a linear combination of the one or more left singular vectors; a channel quality indicator (CQI) of the transmission channel; and a rank indicator (RI) of the transmission channel. For example, referring to FIG. 5, when the UE 502 determines the channel information and the target output at 510. The UE 502 may apply singular value decomposition on the channel estimation to obtain one or more singular values, one or more right singular vectors, and one or more left singular vectors. Then, when the UE transmits, at 512, the channel information and the target output to the UE 502. The target output may include one or more of: the one or more singular values, the one or more right singular vectors or a linear combination of the one or more right singular vectors, and the one or more left singular vectors or a linear combination of the one or more left singular vectors. Additionally, the UE 502 may transmit, at 512, one or more of the CQI of the transmission channel and the RI of the transmission channel to the network entity (base station 504).

In some aspects, the channel information may include a first set of singular vectors associated with the first CSI-RS, and the target output may include a second set of singular vectors associated with the second CSI-RS. For example, referring to FIG. 5, after the UE 502 received the first CSI-RS at 506 and the second CSI-RS at 508, the UE 502 may apply, for example, singular value decomposition on the first CSI-RS and second CSI-RS to obtain, respectively, the first set of singular vectors associated with the first CSI-RS and the second set of singular vectors associated with the second CSI-RS. When the UE transmits, at 512, the channel information and the target output to the network entity (base station 504), the channel information may include the first set of singular vectors and the target output may include the second set of singular vectors.

In some aspects, the network entity could further denoise the channel information received from the UE based on the first set of singular vectors and the second set of singular vectors. For example, referring to FIG. 5, the network entity (base station 504) may, at 516, denoise the channel information received from the UE (e.g., compressed CSI) based on the first set of singular vectors and the second set of singular vectors.

In some aspects, the network entity may transmit a quantization level to the UE. Elements of the target output may be quantized at the quantization level. For example, referring to FIG. 5, prior to step 512, the network entity (base station 504) may transmit a quantization level to the UE 502. When the UE 502 transmits, at 512, the channel information and the target output to the network entity (base station 504), Elements of the target output may be quantized at the quantization level.

In some aspects, the network entity may receive a channel estimation signal-to-noise ratio (SNR) from the UE, and adjust, based on the channel estimation SNR, the quantization level or a transmission power for the second CSI-RS. For example, referring to FIG. 5, the network entity (base station 504) may receive a channel estimation signal-to-noise ratio (SNR) from the UE 502. Then, the network entity (base station 504) may adjust the quantization level based on the channel estimation SNR, or adjust a transmission power for the second CSI-RS before transmitting the second CSI-RS to the UE 502 at 508.

In some aspects, the network entity may transmit the second CSI-RS periodically, aperiodically, or semi-persistently for a preset duration of time. For example, referring to FIG. 5, the network entity (base station 504) may transmit, at 508, the second CSI-RS to the UE 502 periodically, aperiodically, or semi-persistently for a preset duration of time.

In some aspects, the network entity may receive a request for the second CSI-RS from the UE. The network entity may transmit the second CSI-RS in response to the request for the second CSI-RS. For example, referring to FIG. 5, the network entity (base station 504) may receive a request for the second CSI-RS from the UE 502. Then, the transmission of the second CSI-RS at 508 may be performed in response to the request for the second CSI-RS received from the UE 502.

In some aspects, the second CSI-RS may be broadcast to multiple UEs. For example, referring to FIG. 5, when the network entity (base station 504) transmit, at 508, the second CSI-RS to the UE 502, the second CSI-RS may also be broadcast to multiple UEs.

In some aspects, the network entity may receive a sounding reference signal (SRS) over one or more beams for the UE from the UE. Then, the network entity may transmit the second CSI-RS along the one or more beams based on the SRS. For example, referring to FIG. 5, prior to step 508, the network entity (base station 504) may receive an SRS over one or more beams for the UE 502 from the UE 502. Then, when the network entity (base station 504) may transmit the second CSI-RS at 508, the network entity (base station 504) may transmit the second CSI-RS along the one or more beams based on the SRS.

In some aspects, the network entity may transmit the second CSI-RS at a higher transmission power than the first CSI-RS. For example, referring to FIG. 5, when the network entity (base station 504) transmit, at 508, the second CSI-RS, the second CSI-RS may be transmitted at a higher transmission power than the first CSI-RS, which was transmitted at 506.

In some aspects, the network entity may receive the channel information of the transmission channel and the target output under a relaxed delay in comparison to the first CSI-RS. For example, referring to FIG. 5, the network entity (base station 504) may receive, at 512, the channel information of the transmission channel and the target output under a relaxed delay in comparison to the first CSI-RS.

In some aspects, the network entity may receive the channel information of the transmission channel and the target output over one or more of Wi-Fi or during an off-peak time period. For example, referring to FIG. 5, the network entity (base station 504) may receive, at 512, the channel information of the transmission channel and the target output over one or more of Wi-Fi or during an off-peak time period.

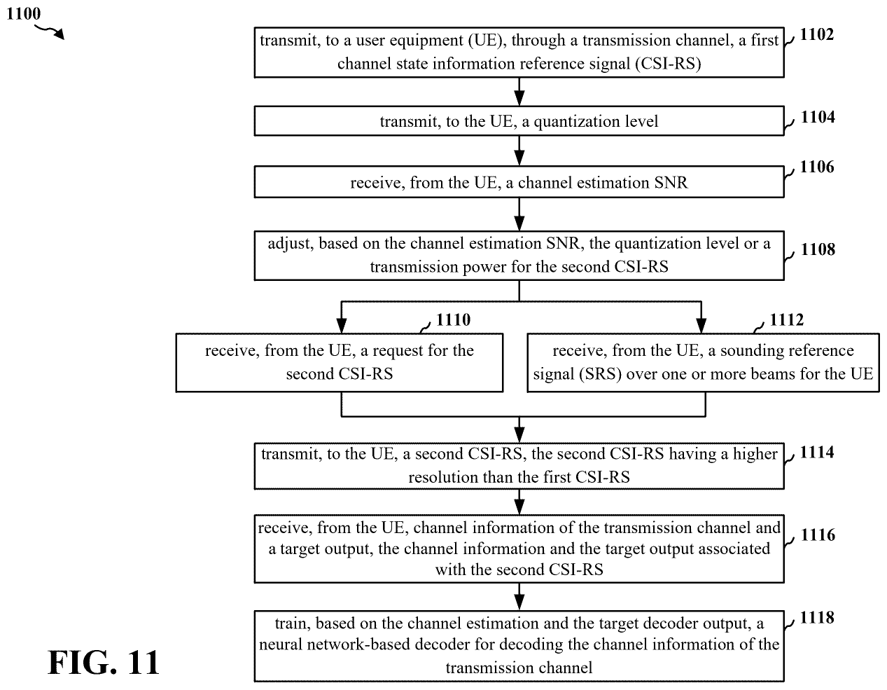

FIG. 11 is a flowchart 1100 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310; CU 110; DU 130; RU 140; base station 504; or the network entity 1202 in the hardware implementation of FIG. 12). This method enables the network entity to accurately train a neural network for decoding the encoded signal received from the UE and perform the denoising process on the encoded signal. Thus, it improves the efficiency and accuracy of wireless communication.

As shown in FIG. 11, at 1102, the network entity may transmit to a UE, through a transmission channel, a first CSI-RS. The UE may be the UE 104, 350, 502, or the UE 104 in the hardware implementation of FIG. 12. FIG. 5 illustrates various aspects of the wireless communication method in connection with flowchart 1100. For example, referring to FIG. 5, the network entity (base station 504) may transmit, at 506, to a UE 502, through a transmission channel, a first CSI-RS. The transmission may be performed, e.g., by the CSI-RS transmitting component 199, transceiver 1246 and/or antenna 1280.

At 1114, the network entity may transmit, to the UE, a second CSI-RS. The second CSI-RS may have a higher resolution than the first CSI-RS. For example, referring to FIG. 5, the network entity (base station 504) may transmit, at 508, a second CSI-RS to the UE 502. The second CSI-RS may have a higher resolution than the first CSI-RS. The transmission may be performed, e.g., by the CSI-RS transmitting component 199, transceiver 1246 and/or antenna 1280.

At 1116, the network entity may receive, from the UE, channel information of the transmission channel and a target output. The channel information and the target output associated with the second CSI-RS. For example, referring to FIG. 5, the network entity (base station 504) may receive, at 512, channel information of the transmission channel and a target output from the UE 502. The channel information and the target output may be associated with the second CSI-RS. The reception may be performed, e.g., by the CSI-RS transmitting component 199, transceiver 1246 and/or antenna 1280.

In some aspects, the channel information may include a channel estimation of the transmission channel based on the second CSI-RS, and the target output may include a target decoder output associated with the channel estimation. For example, referring to FIG. 5, the UE 502 may, at 510, determine channel information and a target output based on the second CSI-RS it received at 508. The channel information may include a channel estimation of the transmission channel, and the target output may include a decoder output associated with the channel estimation. Then, at 512, the network entity (base station 504) may receive the channel estimation and the decoder output associated with the channel estimation.

In some aspects, the network entity may, at 1118, train a neural network-based decoder for decoding the channel information of the transmission channel based on the channel estimation and the target decoder output. For example, referring to FIG. 5, the network entity (base station 504) may train, at 514, a neural network-based decoder for decoding the channel information of the transmission channel based on the channel estimation and the target decoder output.

In some aspects, the target output may further include one or more of: one or more singular values; one or more right singular vectors or a linear combination of the one or more right singular vectors; one or more left singular vectors or a linear combination of the one or more left singular vectors; a channel quality indicator (CQI) of the transmission channel; and a rank indicator (RI) of the transmission channel. For example, referring to FIG. 5, when the UE 502 determines the channel information and the target output at 510. The UE 502 may apply singular value decomposition on the channel estimation to obtain one or more singular values, one or more right singular vectors, and one or more left singular vectors. Then, when the UE transmits, at 512, the channel information and the target output to the UE 502. The target output may include one or more of: the one or more singular values, the one or more right singular vectors or a linear combination of the one or more right singular vectors, and the one or more left singular vectors or a linear combination of the one or more left singular vectors. Additionally, the UE 502 may transmit, at 512, one or more of the CQI of the transmission channel and the RI of the transmission channel to the network entity (base station 504).

In some aspects, the channel information may include a first set of singular vectors associated with the first CSI-RS, and the target output may include a second set of singular vectors associated with the second CSI-RS. For example, referring to FIG. 5, after the UE 502 received the first CSI-RS at 506 and the second CSI-RS at 508, the UE 502 may apply, for example, singular value decomposition on the first CSI-RS and second CSI-RS to obtain, respectively, the first set of singular vectors associated with the first CSI-RS and the second set of singular vectors associated with the second CSI-RS. When the UE transmits, at 512, the channel information and the target output to the network entity (base station 504), the channel information may include the first set of singular vectors and the target output may include the second set of singular vectors.

In some aspects, the network entity could further denoise the channel information received from the UE based on the first set of singular vectors and the second set of singular vectors. For example, referring to FIG. 5, the network entity (base station 504) may, at 516, denoise the channel information received from the UE (e.g., compressed CSI) based on the first set of singular vectors and the second set of singular vectors.

In some aspects, the network entity may transmit, at 1104, a quantization level to the UE. Elements of the target output may be quantized at the quantization level. For example, referring to FIG. 5, prior to step 512, the network entity (base station 504) may transmit a quantization level to the UE 502. When the UE 502 transmits, at 512, the channel information and the target output to the network entity (base station 504), Elements of the target output may be quantized at the quantization level. The transmission may be performed, e.g., by the CSI-RS transmitting component 199, transceiver 1246 and/or antenna 1280.

In some aspects, the network entity may receive, at 1106, a channel estimation signal-to-noise ratio (SNR) from the UE, and adjust, at 1108, based on the channel estimation SNR, the quantization level or a transmission power for the second CSI-RS. For example, referring to FIG. 5, the network entity (base station 504) may receive a channel estimation signal-to-noise ratio (SNR) from the UE 502. Then, the network entity (base station 504) may adjust the quantization level based on the channel estimation SNR, or adjust a transmission power for the second CSI-RS before transmitting the second CSI-RS to the UE 502 at 508. The reception may be performed, e.g., by the CSI-RS transmitting component 199, transceiver 1246 and/or antenna 1280.

In some aspects, the network entity may transmit the second CSI-RS periodically, aperiodically, or semi-persistently for a preset duration of time. For example, referring to FIG. 5, the network entity (base station 504) may transmit, at 508, the second CSI-RS to the UE 502 periodically, aperiodically, or semi-persistently for a preset duration of time.

In some aspects, the network entity may receive, at 1110, a request for the second CSI-RS from the UE. The network entity may transmit the second CSI-RS in response to the request for the second CSI-RS. For example, referring to FIG. 5, the network entity (base station 504) may receive a request for the second CSI-RS from the UE 502. Then, the transmission of the second CSI-RS at 508 may be performed in response to the request for the second CSI-RS received from the UE 502. The reception may be performed, e.g., by the CSI-RS transmitting component 199, transceiver 1246 and/or antenna 1280.

In some aspects, the second CSI-RS may be broadcast to multiple UEs. For example, referring to FIG. 5, when the network entity (base station 504) transmit, at 508, the second CSI-RS to the UE 502, the second CSI-RS may also be broadcast to multiple UEs.

In some aspects, the network entity may receive, at 1112, a sounding reference signal (SRS) over one or more beams for the UE from the UE. Then, the network entity may transmit the second CSI-RS along the one or more beams based on the SRS. For example, referring to FIG. 5, prior to step 508, the network entity (base station 504) may receive an SRS over one or more beams for the UE 502 from the UE 502. Then, when the network entity (base station 504) may transmit the second CSI-RS at 508, the network entity (base station 504) may transmit the second CSI-RS along the one or more beams based on the SRS. The reception may be performed, e.g., by the CSI-RS transmitting component 199, transceiver 1246 and/or antenna 1280.

In some aspects, the network entity may transmit the second CSI-RS at a higher transmission power than the first CSI-RS. For example, referring to FIG. 5, when the network entity (base station 504) transmit, at 508, the second CSI-RS, the second CSI-RS may be transmitted at a higher transmission power than the first CSI-RS, which was transmitted at 506.

In some aspects, the network entity may receive the channel information of the transmission channel and the target output under a relaxed delay in comparison to the first CSI-RS. For example, referring to FIG. 5, the network entity (base station 504) may receive, at 512, the channel information of the transmission channel and the target output under a relaxed delay in comparison to the first CSI-RS.

In some aspects, the network entity may receive the channel information of the transmission channel and the target output over one or more of Wi-Fi or during an off-peak time period. For example, referring to FIG. 5, the network entity (base station 504) may receive, at 512, the channel information of the transmission channel and the target output over one or more of Wi-Fi or during an off-peak time period.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include at least one on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to transmit, to a UE, through a transmission channel, a first CSI-RS. The component 199 is further configured to transmit a second CSI-RS to the UE, and receive channel information of the transmission channel and a target output from the UE. The second CSI-RS may have a higher resolution than the first CSI-RS, and the channel information and the target output may be associated with the second CSI-RS. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium (e.g., at least one memory) for implementation by one or more processors, or some combination thereof. When multiple processors are implemented, the multiple processors may perform the stated processes/algorithm individually or in combination, e.g., individually or collectively. The network entity 1202 may include a variety of components configured for various functions. In one configuration, the network entity 1202 includes means for transmitting, through a transmission channel, a first CSI-RS to a UE, means for transmitting a second CSI-RS having a higher resolution than the first CSI-RS to the UE, and means for receiving channel information of the transmission channel and a target output from the UE, the channel information and the target output associated with the second CSI-RS. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes receiving, through a transmission channel, a first CSI-RS; receiving a second CSI-RS, the second CSI-RS having a higher resolution than the first CSI-RS; and transmitting channel information of the transmission channel and a target output, the channel information and the target output associated with the second CSI-RS.

Aspect 2 is the method of aspect 1, where the channel information includes a channel estimation of the transmission channel based on the second CSI-RS, and the target output includes a target decoder output associated with the channel estimation.

Aspect 3 is the method of aspect 2, where the target output includes one or more of: one or more singular values; one or more right singular vectors or a first linear combination of the one or more right singular vectors; one or more left singular vectors or a second linear combination of the one or more left singular vectors; a CQI of the transmission channel; and an RI of the transmission channel.

Aspect 4 is the method of aspect 3, where the channel information includes a first set of singular vectors associated with the first CSI-RS, and the target output includes a second set of singular vectors associated with the second CSI-RS.

Aspect 5 is the method of any of aspects 1 to 4, where the method further includes receiving an indication of a quantization level, and where elements of the target output are quantized at the quantization level.

Aspect 6 is the method of aspect 5, where the method further includes transmitting a channel estimation SNR; and receiving, based on the channel estimation SNR, an adjusted quantization level or the second CSI-RS having an adjusted transmission power.

Aspect 7 is the method of any of aspects 1 to 6, where the second CSI-RS is periodic, aperiodic, or semi-persistent for a preset duration of time.

Aspect 8 is the method of aspect 7, where the method further includes transmitting a request for the second CSI-RS, and where the second CSI-RS is received in response to the request for the second CSI-RS.

Aspect 9 is the method of any of aspects 1 to 8, where the second CSI-RS is common to multiple UEs or the second CSI-RS has a higher transmission power than the first CSI-RS.

Aspect 10 is the method of any of aspects 1 to 9, where the method further includes transmitting an SRS over one or more beams, and where the second CSI-RS is received along the one or more beams based on the SRS.

Aspect 11 is the method of any of aspects 1 to 10, where the channel information of the transmission channel and the target output are transmitted under a relaxed delay in comparison to the first CSI-RS, over Wi-Fi, or during an off-peak period.

Aspect 12 is the method of any of aspects 1 to 11, where transmitting the channel information of the transmission channel and the target output may include transmitting the channel information of the transmission channel and the target output via a L3 message.

Aspect 13 is the method of any of aspects 1 to 12, where transmitting the channel information of the transmission channel and the target output may include transmitting, in response to an expiration of a timer, the channel information of the transmission channel and the target output.

Aspect 14 is the method of aspect 13, where the method may further include transmitting, in response to a condition change on the transmission channel, a CSI-RS request.

Aspect 15 is the method of aspect 14, where the condition change on the transmission channel may include the change of CLI. The change of the CLI may be determined based on the RSRP or the RSSI measured by the UE.

Aspect 16 is an apparatus for wireless communication at a UE, including: at least one memory; and at least one processor coupled to the memory and, based at least in part on information stored in the memory, the at least one processor, individually or in any combination, is configured to perform the method of any of aspects 1-15.

Aspect 17 is the apparatus of aspect 16, further including at least one of one or more transceivers or one or more antennas coupled to the at least one processor and configured to receive the first CSI-RS and the second CSI-RS.

Aspect 18 is an apparatus for wireless communication including means for implementing the method of any of aspects 1-15.

Aspect 19 is a computer-readable medium (e.g., a non-transitory computer-readable medium) storing computer executable code, where the code when executed by at least one processor causes the at least one processor to implement the method of any of aspects 1-15.

Aspect 20 is a method of wireless communication at a network entity. The method includes transmitting, through a transmission channel, a first CSI-RS to a UE; transmitting a second CSI-RS to the UE, the second CSI-RS having a higher resolution than the first CSI-RS; and receiving channel information of the transmission channel and a target output from the UE, the channel information and the target output associated with the second CSI-RS.

Aspect 21 is the method of aspect 20, where the channel information includes a channel estimation of the transmission channel based on the second CSI-RS, and the target output includes a target decoder output associated with the channel estimation.

Aspect 22 is the method of aspect 21, wherein the method further includes training, by the network entity, based on the channel estimation and the target decoder output, a neural network-based decoder for decoding the channel information of the transmission channel.

Aspect 23 is the method of aspect 21, where the target output further includes one or more of: one or more singular values; one or more right singular vectors or a first linear combination of the one or more right singular vectors; one or more left singular vectors or a second linear combination of the one or more left singular vectors; a CQI of the transmission channel; and an RI of the transmission channel.

Aspect 24 is the method of aspect 20, where the channel information includes a first set of singular vectors associated with the first CSI-RS, and the target output includes a second set of singular vectors associated with the second CSI-RS, and the method further includes denoising, based on the first set of singular vectors and the second set of singular vectors, the channel information received from the UE.

Aspect 25 is the method of any of aspects 20 to 24, where the method further includes transmitting a quantization level to the UE, and where elements of the target output are quantized at the quantization level.

Aspect 26 is the method of aspect 25, where the method may further include receiving, from the UE, a channel estimation SNR; and adjusting, based on the channel estimation SNR, the quantization level or a transmission power for the second CSI-RS.

Aspect 27 is the method of any of aspects 20 to 26, where the second CSI-RS may be transmitted periodically, aperiodically, or semi-persistently for a preset duration of time.

Aspect 28 is the method of any of aspects 20 to 27, where the method may further include receiving, from the UE, a request for the second CSI-RS, and the second CSI-RS is transmitted in response to the request for the second CSI-RS.

Aspect 29 is the method of any of aspects 20 to 28, where the second CSI-RS may be included in a broadcast to multiple UEs, or the second CSI-RS has a higher transmission power than the first CSI-RS.

Aspect 30 is the method of any of aspects 20 to 29, where the method may further include receiving, form the UE, an SRS over one or more beams for the UE, and the second CSI-RS is transmitted along the one or more beams based on the SRS.

Aspect 31 is the method of any of aspects 20 to 30, where the channel information of the transmission channel and the target output may be received under a relaxed delay in comparison to the first CSI-RS.

Aspect 32 is the method of any of aspects 20 to 31, where receiving the channel information of the transmission channel and the target output may include: receiving the channel information of the transmission channel and the target output via a L3 message.

Aspect 33 is an apparatus for wireless communication at a network entity, including: at least one memory; and at least one processor coupled to the at least one memory and, based at least in part on information stored in the memory, the at least one processor, individually or in any combination, is configured to perform the method of any of aspects 20-32.

Aspect 34 is the apparatus of aspect 33, further including at least one of one or more transceivers or one or more antennas coupled to the at least one processor and configured to transmit the first CSI-RS and the second CSI-RS.

Aspect 35 is an apparatus for wireless communication including means for implementing the method of any of aspects 20-32.

Aspect 36 is a computer-readable medium (e.g., a non-transitory computer-readable medium) storing computer executable code, where the code when executed by at least one processor causes the at least one processor to implement the method of any of aspects 20-32.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, through a transmission channel, a first channel state information reference signal (CSI-RS);
receive a second CSI-RS, the second CSI-RS having a higher resolution than the first CSI-RS; and
transmit channel information of the transmission channel and a target output, the channel information and the target output associated with the second CSI-RS.

2. The apparatus of claim 1, further comprising at least one transceiver coupled to the at least one processor, wherein, to receive the first CSI-RS and the second CSI-RS, the at least one processor is configured to receive the first CSI-RS and the second CSI-RS via the at least one transceiver, and wherein the channel information comprises a channel estimation of the transmission channel based on the second CSI-RS, and the target output includes a target decoder output associated with the channel estimation.

3. The apparatus of claim 2, wherein the target output comprises one or more of:
one or more singular values;
one or more right singular vectors or a first linear combination of the one or more right singular vectors;
one or more left singular vectors or a second linear combination of the one or more left singular vectors;
a channel quality indicator (CQI) of the transmission channel; or
a rank indicator (RI) of the transmission channel.

4. The apparatus of claim 1, wherein the channel information comprises a first set of singular vectors associated with the first CSI-RS, and the target output comprises a second set of singular vectors associated with the second CSI-RS.

5. The apparatus of claim 1, wherein the at least one processor is further configured to:
receive an indication of a quantization level, and wherein elements of the target output are quantized at the quantization level.

6. The apparatus of claim 5, wherein the at least one processor is further configured to:
transmit a channel estimation signal-to-noise ratio (SNR); and
receive, based on the channel estimation SNR, an adjusted quantization level or the second CSI-RS having an adjusted transmission power.

7. The apparatus of claim 1, wherein the second CSI-RS is periodic, aperiodic, or semi-persistent for a preset duration of time.

8. The apparatus of claim 7, wherein the at least one processor is further configured to:
transmit a request for the second CSI-RS, and wherein the second CSI-RS is received in response to the request for the second CSI-RS.

9. The apparatus of claim 1, wherein the second CSI-RS is common to multiple UEs, or the second CSI-RS has a higher transmission power than the first CSI-RS.

10. The apparatus of claim 1, wherein the at least one processor is further configured to:
transmit a sounding reference signal (SRS) over one or more beams, and wherein the second CSI-RS is received along the one or more beams based on the SRS.

11. The apparatus of claim 1, wherein, to transmit the channel information of the transmission channel and the target output, the at least one processor is further configured to:
transmit the channel information of the transmission channel and the target output under a relaxed delay in comparison to the first CSI-RS, over Wi-Fi, or during an off-peak time period.

12. The apparatus of claim 1, wherein, to transmit the channel information of the transmission channel and the target output, the at least one processor is further configured to:
transmit the channel information of the transmission channel and the target output via a layer 3 (L3) message.

13. The apparatus of claim 1, wherein, to transmit the channel information of the transmission channel and the target output, the at least one processor is further configured to:
transmit, in response to an expiration of a timer, the channel information of the transmission channel and the target output.

14. The apparatus of claim 13, wherein the at least one processor is further configured to:
transmit, in response to a condition change on the transmission channel, a CSI-RS request.

15. The apparatus of claim 14, wherein the condition change on the transmission channel comprises a change of cross-link interference (CLI), wherein the change of the CLI is determined based on a Reference Signal Received Power (RSRP) or a Received Signal Strength Indicator (RSSI) measured by the UE.

16. A method of wireless communication at a user equipment (UE), comprising:
receiving, through a transmission channel, a first channel state information reference signal (CSI-RS);
receiving a second CSI-RS, the second CSI-RS having a higher resolution than the first CSI-RS; and
transmitting channel information of the transmission channel and a target output, the channel information and the target output associated with the second CSI-RS.

17. An apparatus for wireless communication at a network entity, comprising:
at least one memory; and
at least one processor coupled to the at least one memory and, based at least in part on information stored in the at least one memory, the at least one processor, individually or in any combination, is configured to:
transmit, to a user equipment (UE), through a transmission channel, a first channel state information reference signal (CSI-RS);
transmit, to the UE, a second CSI-RS, the second CSI-RS having a higher resolution than the first CSI-RS; and
receive, from the UE, channel information of the transmission channel and a target output, the channel information and the target output associated with the second CSI-RS.

18. The apparatus of claim 17, further comprising at least one transceiver coupled to the at least one processor, wherein, to transmit the first CSI-RS and the second CSI-RS, the at least one processor is configured to transmit the first CSI-RS and the second CSI-RS via the at least one transceiver, and wherein the channel information comprises a channel estimation of the transmission channel based on the second CSI-RS, and the target output includes a target decoder output associated with the channel estimation.

19. The apparatus of claim 18, wherein the at least one processor is further configured to:
train, by the network entity, based on the channel estimation and the target decoder output, a neural network-based decoder for decoding the channel information of the transmission channel.

20. The apparatus of claim 18, wherein the target output further comprises one or more of:
one or more singular values;
one or more right singular vectors or a first linear combination of the one or more right singular vectors;
one or more left singular vectors or a second linear combination of the one or more left singular vectors;
a channel quality indicator (CQI) of the transmission channel; or
a rank indicator (RI) of the transmission channel.

21. The apparatus of claim 17, wherein the channel information comprises a first set of singular vectors associated with the first CSI-RS, and the target output comprises a second set of singular vectors associated with the second CSI-RS, and wherein the at least one processor is further configured to:
denoise, based on the first set of singular vectors and the second set of singular vectors, the channel information received from the UE.

22. The apparatus of claim 17, wherein the at least one processor is further configured to:
transmit, to the UE, a quantization level, and wherein elements of the target output are quantized at the quantization level.

23. The apparatus of claim 22, wherein the at least one processor is further configured to:
receive, from the UE, a channel estimation signal-to-noise ratio (SNR); and
adjust, based on the channel estimation SNR, the quantization level or a transmission power for the second CSI-RS.

24. The apparatus of claim 17, wherein to transmit the second CSI-RS, the at least one processor is configured to:
transmit the second CSI-RS periodically, aperiodically, or semi-persistently for a preset duration of time.

25. The apparatus of claim 24, wherein the at least one processor is further configured to:
receive, from the UE, a request for the second CSI-RS, and transmit the second CSI-RS is in response to the request for the second CSI-RS.

26. The apparatus of claim 17, wherein the second CSI-RS is comprised in a broadcast to multiple UEs, or the second CSI-RS has a higher transmission power than the first CSI-RS.

27. The apparatus of claim 17, wherein the at least one processor is further configured to:
receive, from the UE, a sounding reference signal (SRS) over one or more beams for the UE, and transmit the second CSI-RS along the one or more beams based on the SRS.

28. The apparatus of claim 17, wherein, to receive the channel information of the transmission channel and the target output, the at least one processor is further configured to:
receive the channel information of the transmission channel and the target output under a relaxed delay in comparison to the first CSI-RS.

29. The apparatus of claim 17, wherein, to receive the channel information of the transmission channel and the target output, the at least one processor is configured to:
receive the channel information of the transmission channel and the target output via a layer 3 (L3) message.

30. A method of wireless communication at a network entity, comprising:
transmitting, to a user equipment (UE), through a transmission channel, a first channel state information reference signal (CSI-RS);
transmitting, to the UE, a second CSI-RS, the second CSI-RS having a higher resolution than the first CSI-RS; and
receiving, from the UE, channel information of the transmission channel and a target output, the channel information and the target output associated with the second CSI-RS.
